(19) United States
(12) Patent Application Publication
(10) Pub. No.: US 2019/0059451 A1
(43) Pub. Date: Feb. 28, 2019

(54) Detachable T-Shirt Collar

(71) Applicant: PAUL HASTINGS, Oakville (CA)

(72) Inventor: PAUL HASTINGS, Oakville (CA)

(21) Appl. No.: 15/838,291

(22) Filed: Dec. 11, 2017

(30) Foreign Application Priority Data
Aug. 23, 2017 (CA) 2977144

(51) Int. Cl. A41B 3/04; A41B 5/00; A41F 1/00; G09F 13/20; G09F 21/02

(52) U.S. Cl. CPC A41B 3/04; A41B 5/00; A41F 1/002; A41B 3/10; G09F 13/20; G09F 21/026; A41F 1/00

(57) ABSTRACT

In the clothing industry, it is known to have detachable collars for shirts as far back as the 1880's. Since then there has been detachable hoodies, detachable raingear and other detachable accessories, where the attachment tabs or buttons or fasteners were integral with the shirt or the shirt already had a provision for attachment of a collar, similar to what some pastors/clergy wear. In this invention, the detachable T-shirt collar, DTSC, is for a regular T-shirt without any provision for a detachable collar. This invented collar is attached through or close to the stretchable T-shirt collar band at the neck to transform a regular T-shirt, old or new into a more formal attire. The collar attachment is for the standard O-neck and V-neck and the stretchable T-shirt material is compatible with the collar material. The fastening method can use various methods such as paired magnets, paired male and female clip connectors and tension clips that open and close, all of which can be made from a variety of materials such as metal or plastic.

This invention relates to a detachable T-shirt collar for a typical common T-shirt where the collar can be attached and reattached very quickly without damaging the T-shirt.

It is common for T-shirts to be of different colors where they are used for casual settings and the cost of collarless T-shirts are very cheap in comparison to shirts with collars. Sport activities or informal work activities where T-shirts are worn by a variety of age groups can have the T-shirt transformed with a simple collar addition or collar change that is both economical and fashionable. This improvement allows a wider group of persons the choice for fashion upgrade on a limited budget. The collars can be of various fabrics with the fastening device concealed by the exterior face of the DTSC or by an additional fold in the collar itself of the DTSC. The collar is separately washable, detachable and fashionable and is for males and females. The exterior face can be articulated for a fashion statement design, and the colors can be for specific recognition of a group or company. The collar can be optioned with a “belt loop-type” feature where a color choice or message strip can be inserted separately. The cloth fabric can be stitched in production at the fold lines to the adjacent face to maintain the shape of the collar when it is attached. Other material types may require starching or gluing at the fold lines.

Additionally, the detachable collar can be an assembly of similar or dissimilar materials or fabrics stitched or joined together at the folds so that different materials can be used but held together so the detachable feature is maintained. This is an additional method of making the detachable collar from one piece of material or fabric and folded to form.

The DTSC uses the folded material to cover the connections to the T-shirt collar band and protect the wearer's skin from any allergic reaction from the connectors.

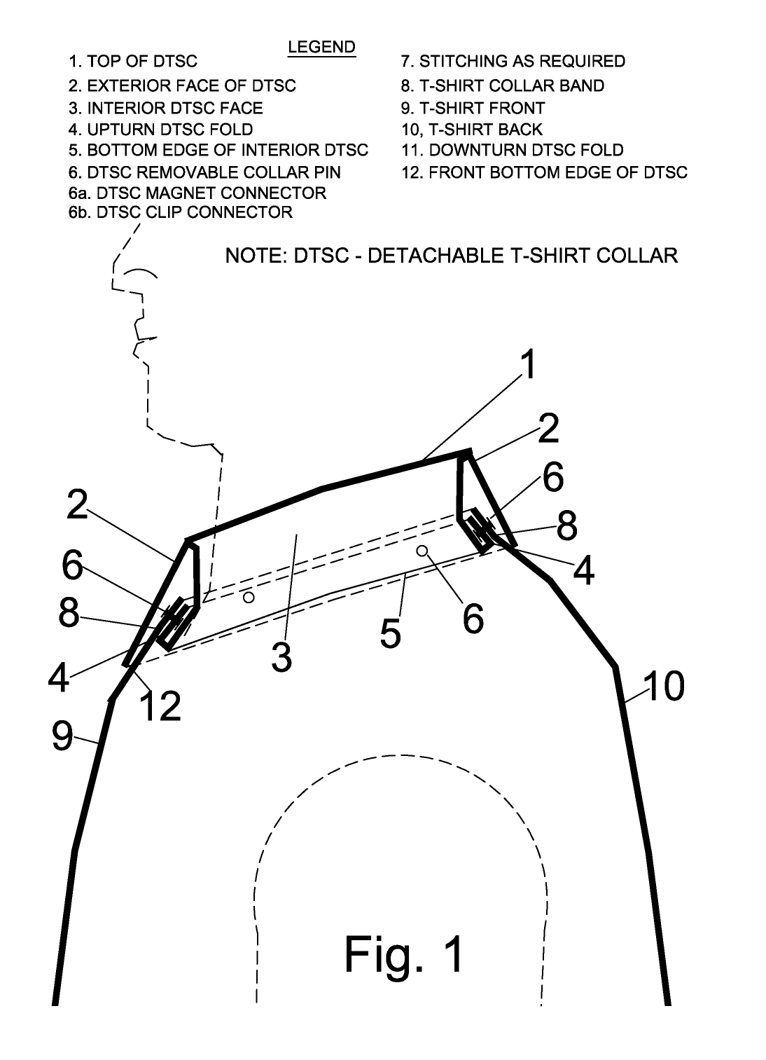

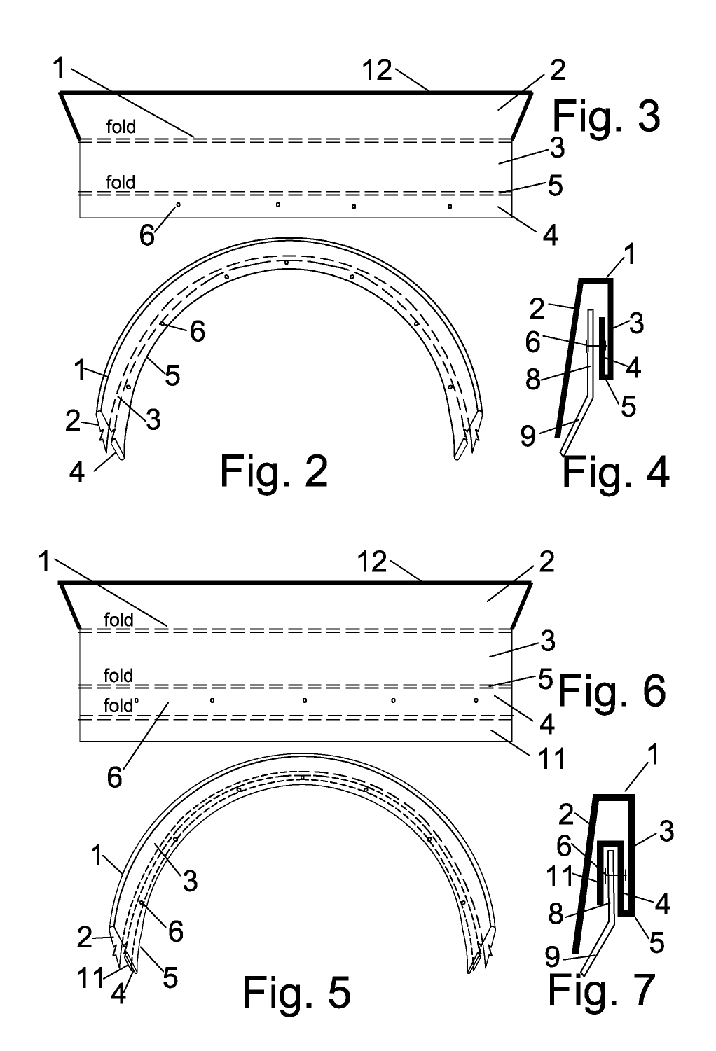

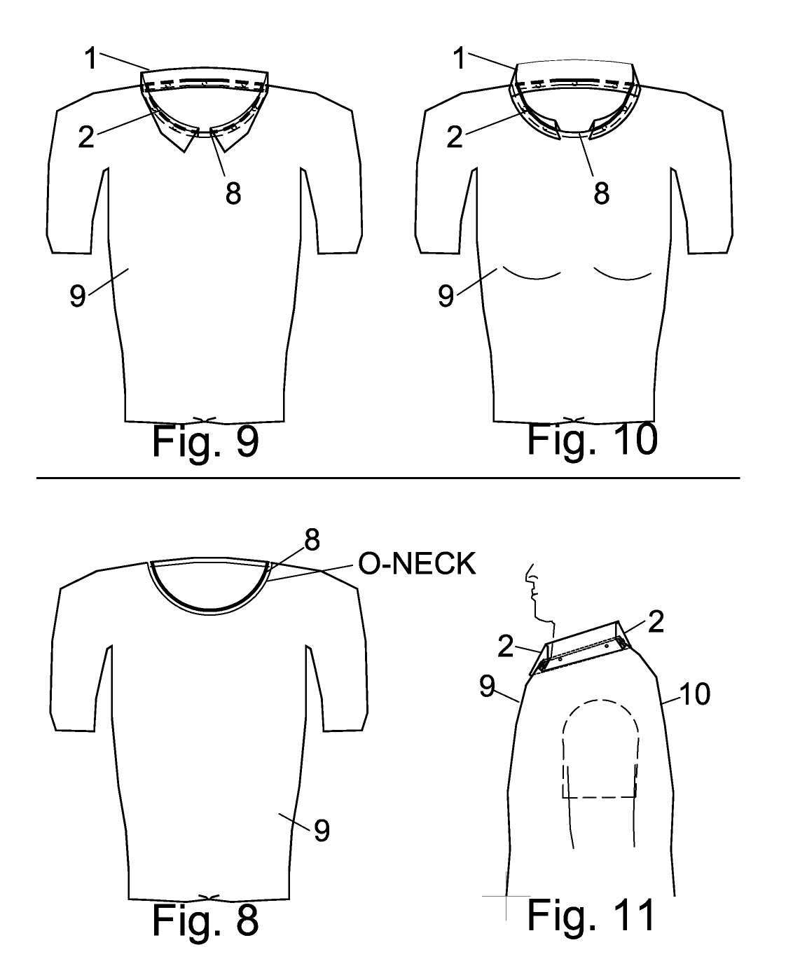

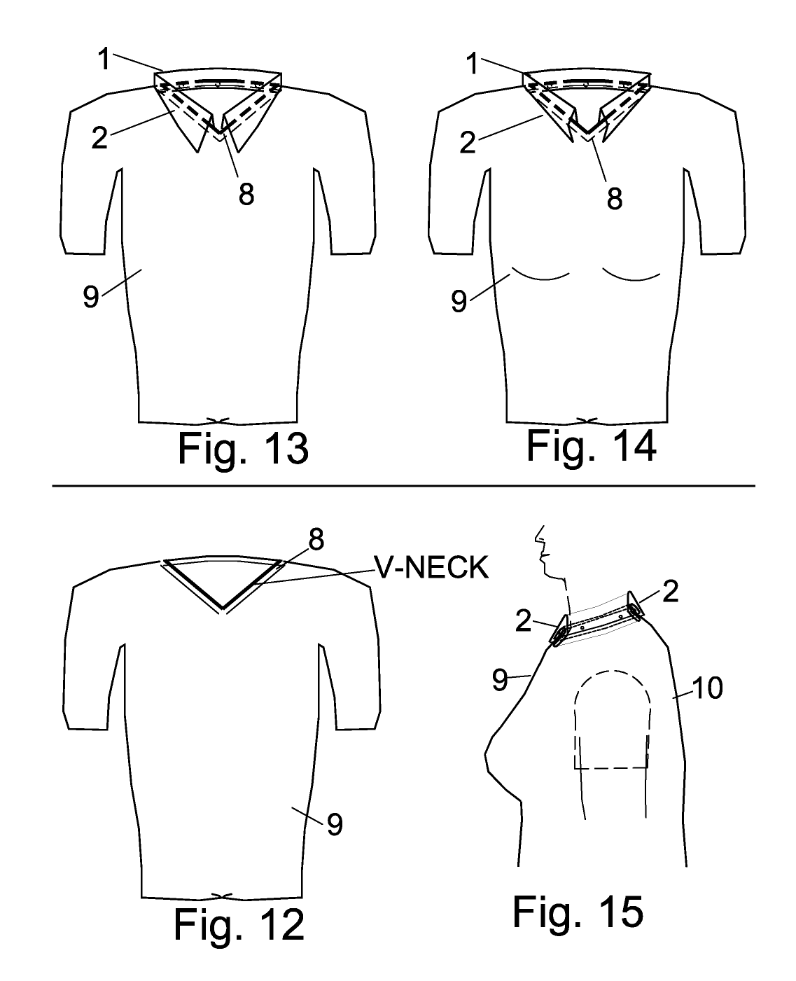

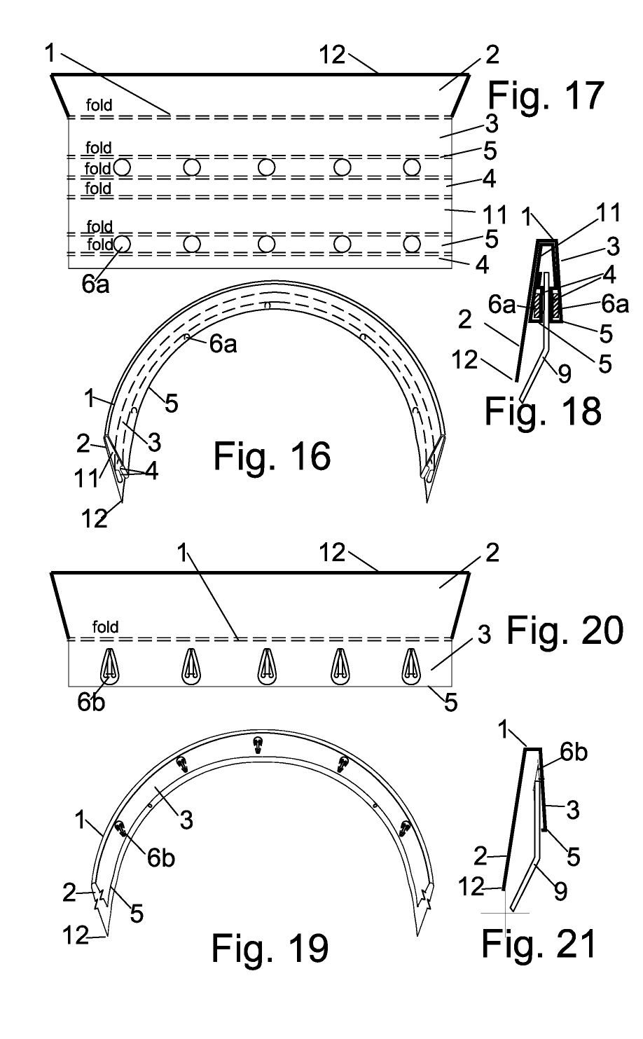

Drawing List: Detachable T-Shirt Collar, DTSC

| | |
|---|---|
| FIG. 1 - Section view of 2 fold DTSC | |
| FIG. 2 - 3D view of 2 fold DTSC | FIG. 5 - 3D view of 3 fold DTSC |
| FIG. 3 - Elevation of 2 fold DTSC | FIG. 6 - Elevation of 3 fold DTSC |
| FIG. 4 - Section view of 2 fold DTSC | FIG. 7 - Section view of 3 fold DTSC |
| FIG. 8 - Front of O-neck T-shirt | FIG. 12 - Front of V-neck T-shirt |
| FIG. 9 - Front of O-Neck with DTSC | FIG. 13 - Front of V-Neck with DTSC |
| FIG. 10-Front of O neck with DTSC (F) | FIG. 14-Front of V neck with DTSC (F) |
| FIG. 11- Side of O-neck with DTSC (M) | FIG. 15- Side of V-neck with DTSC (F) |
| FIG. 16 -3D view DTSC with magnets | FIG. 19 - 3D view with clips |
| FIG. 17 - Elevation of DTSC with magnets | FIG. 20 - Elevation of DTSC with clips |
| FIG. 18 - Section of DTSC with magnets | FIG. 21 - Section of DTSC with clips |

### DRAWINGS

In drawings which illustrate embodiments of the invention, FIGS. 1, 4, 7 are sectional views that show the attachment relationship of the detachable T-shirt collar to the T-shirt collar band that goes around the neck of the individual. FIGS. 3 and 6 show the flattened strip that is folded to form the sectional views mentioned above to become a 2 fold or 3 fold DTSC type. FIGS. 2 and 5 are a 3D representation of the DTSC types. FIGS. 8 and 9 are the typical front view of a common T-shirt. FIGS. 9, 10, 11,13, 14 and 15 shows the common T-shirt with the DTSC attached. The belt-loop type feature of the DTSC is not shown as it would be in part 2 of FIGS. 3 and 6 and the other occurrences of part 2.

Similarly, FIGS. 18 and 21 show sectional views using magnets and clips to pair the DTSC with the T-shirt collar. FIGS. 17 and 20 show the flattened strip that is folded to contain the grouped magnets and the clips that clip-on and clip-off to the T-shirt collar. The feature part of the DTSC covers the connection to the T-shirt neck band. FIGS. 16 and 19 are 3D representations of the DTSC.

### DESCRIPTION

The Detachable T-shirt Collar that is illustrated in FIGS. 9, 10, 13 and 14 is comprised of fabric material that is cut to a length as shown in FIGS. 3 and 6 and FIGS. 17 and 21 to provide a gap at the front of the T-shirt depending on the circumference of the T-shirt's collar band. Part 4 as shown in FIGS. 1, 4 and 7, and 18 and 21, is sized to match the T-shirt collar band. The height of the collar part 3 at the back as shown in FIGS. 1, 4, and 7 varies but is usually about an 25 mm (1″) plus the height of the collar band and can have a tapered increase at the front towards the previously mentioned gap on either side to form the collar end as shown in FIGS. 9, 10, 13, and 14. The 2 piece fasteners are connected through the T-shirt collar band to the DTSC as shown by part 6, 6a and 6b on FIGS. 1, 2, 3, 4, 5, 6, 7. and FIGS. 16, 17, 18, 19, 20, and 21, with the 2 part pin or connector not coming in contact with the wearer's skin. Both parts of the 2 piece pin assembly are flat and grip each other for assembly and disassembly by separating them apart. When the magnet connector pair in 6a is used or the clip in 6b is used, they can be separated and joined together repeatedly. The fasteners joining 3 and 9 are concealed as shown in FIGS. 1, 4, 7, 18 and 21.

1. The embodiments of the invention in which an exclusive property and privilege is claimed are defined as follows.
A detachable T-shirt collar around the neck of a stretchable O-neck or V-neck T-shirt collar band.
A detachable T-shirt collar as defined in claim 1 that can be washed, ironed, dry cleaned or starched with the end seamed or non-seamed to prevent fraying or to allow fraying for styling effect.
A detachable T-shirt collar as defined in claims 1 and 2 that can be made of a variety of fabrics including quilted or pleated fabrics, fabrics of various colors and design patterns and thin metal mesh.
A detachable T-shirt collar as defined in claim 1, 2 and 3 that can have a belt-like loop type feature in the exterior face for insertion of a color choice or message strip that can also be photo luminescent.
A detachable T-shirt collar as defined in claims 1, 2, 3, and 4 that can have the headphone cord for a wifi inserted in the belt-like loop in the exterior face.
A detachable T-shirt collar as defined in claims 1, 2, 3, 4, and 5 that does not have an upturn or downturn fold and is connected directly to the O-neck or V-neck T shirt collar band.
A detachable T-shirt collar as defined in claims 1, 2, 3, 4, 5, and 6 that uses magnets or clips that allows removable attachment to the T-shirt collar band.
A detachable T-shirt collar as defined in claims 1, 2, 3 4, 5,6, and 7 that uses dissimilar materials or fabrics joined together to form a detachable T-shirt collar and an included form to maintain the shape of the collar.
